(19) United States
(12) Patent Application Publication
(10) Pub. No.: US 2015/0089628 A1
(43) Pub. Date: Mar. 26, 2015

(54) System and Method for Provision of a Router / Firewall in a Network

(71) Applicant: Michael Lang, Bogart, GA (US)

(72) Inventor: Michael Lang, Bogart, GA (US)

(21) Appl. No.: 14/493,462

(22) Filed: Sep. 23, 2014

Related U.S. Application Data
(60) Provisional application No. 61/881,610, filed on Sep. 24, 2013.

(51) Int. Cl. H04L 29/06; H04W 84/02; H04L 29/08

(52) U.S. Cl. CPC H04L 63/0245; H04L 67/141; H04W 84/02
USPC 726/13

(57) ABSTRACT

A firewall/router is configured in a best practices approach for security and performance and, as such, greatly enables non-technical consumers to install it as a gateway point in a small network setting. Certain embodiments provide a means to monitor network usage, configure content filtering, schedule hours of access for certain networked devices and specify which network devices may connect to the WAN. It is envisioned that certain embodiments may also be capable of sending alerts to designated and configurable targets. WAN access may be granted or blocked or throttled on a per network device basis using parameters such as, but not limited to, time of day, throttling characteristics, and classification of the content being served by the target resource.

### CROSS-REFERENCE TO RELATED APPLICATIONS

This claims priority under 35 U.S.C. §119(e) to U.S. provisional application entitled “SYSTEM AND METHOD FOR PROVISION OF A ROUTER/FIREWALL IN A NETWORK,” filed on Sep. 24, 2013 and assigned application Ser. No. 61/881,610, the entire contents of which are hereby incorporated by reference.

### BACKGROUND

There are many known approaches to adding a router to local area networks that variously provides firewall, gateway, intrusion detection and prevention, port forwarding and other such network related services over and above simple routing from LAN to WAN domains via the device. They are often very technical, hard to use, and use verbiage that generally makes sense only to a knowledgeable technical professional. Furthermore, such devices in the residential setting rarely offer security features approaching devices deployed to commercial settings in similar role and are seldom accessed, monitored and configured by residential users once installed. Those devices geared to small networks also are rarely capable of interacting with a cloud service that provides monitoring and alerts for managing certain events detected on the network that the device is attached to.

There are also many software based solutions designed to filter and block content not suitable to certain audiences, which are most frequently installed on the end-point computer. While these software packages introduce a much easier to use interface, the protection they offer are easily defeated by malicious software and users that desire to get around the installed content filters by either disabling the service, deleting the executables, editing system registries, installing disablers, uninstalling the software, booting to live CDs that don't have the firewall/content filtering software and so on.

### BRIEF SUMMARY

Embodiments of the present invention offer a firewall/router that is configured in a best practices approach for security and performance and, as such, greatly enables non-technical consumers to install it as a gateway point in a small network setting. Certain embodiments provide a means to monitor network usage, configure content filtering, schedule hours of access for certain networked devices and specify which network devices may connect to the WAN. It is envisioned that certain embodiments may also be capable of sending alerts to designated and configurable targets. WAN access may be granted or blocked or throttled on a per network device basis using parameters such as, but not limited to, time of day, throttling characteristics, and classification of the content being served by the target resource. Embodiments provide such functionality by way of a novel combination of a browser and mobile-based interfaces. It is a further advantage of certain embodiments that functionality and performance concepts are presented in verbiage that is easy for non-technical consumers to understand and manage.

### BRIEF DESCRIPTION OF THE SEVERAL VIEWS OF THE DRAWING

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 illustrates a typical router deployment and the most common components of a router that has been configured as a gateway and firewall at the edge of a private network.

FIG. 2 depicts a typical residential or small office/home office (SOHO) network with an embodiment used in conjunction with an ISP's provided DSL or Cable Modem.

FIG. 3 depicts a typical residential or small office/home office (SOHO) network with an embodiment with integrated wireless functionality used in conjunction with an ISP's provided DSL or Cable Modem. A wireless router and wired switch may also be present to augment network capacity on the LAN.

FIG. 4 depicts a typical residential or small office/home office (SOHO) network with an embodiment that additionally has DSL or Cable modem hardware integrated to replace an ISP's provided DSL or Cable Modem. A wireless router and wired switch may also be present to augment network capacity on the LAN.

FIG. 5 depicts a typical residential or small office/home office (SOHO) network with an embodiment with integrated wireless functionality that additionally has DSL or Cable modem hardware integrated to replace an ISP's provided DSL or Cable Modem.

FIG. 6 illustrates the flow of decisions made by the device that leads to either the user's WAN request being blocked, redirected to Captive Portal, or allowed.

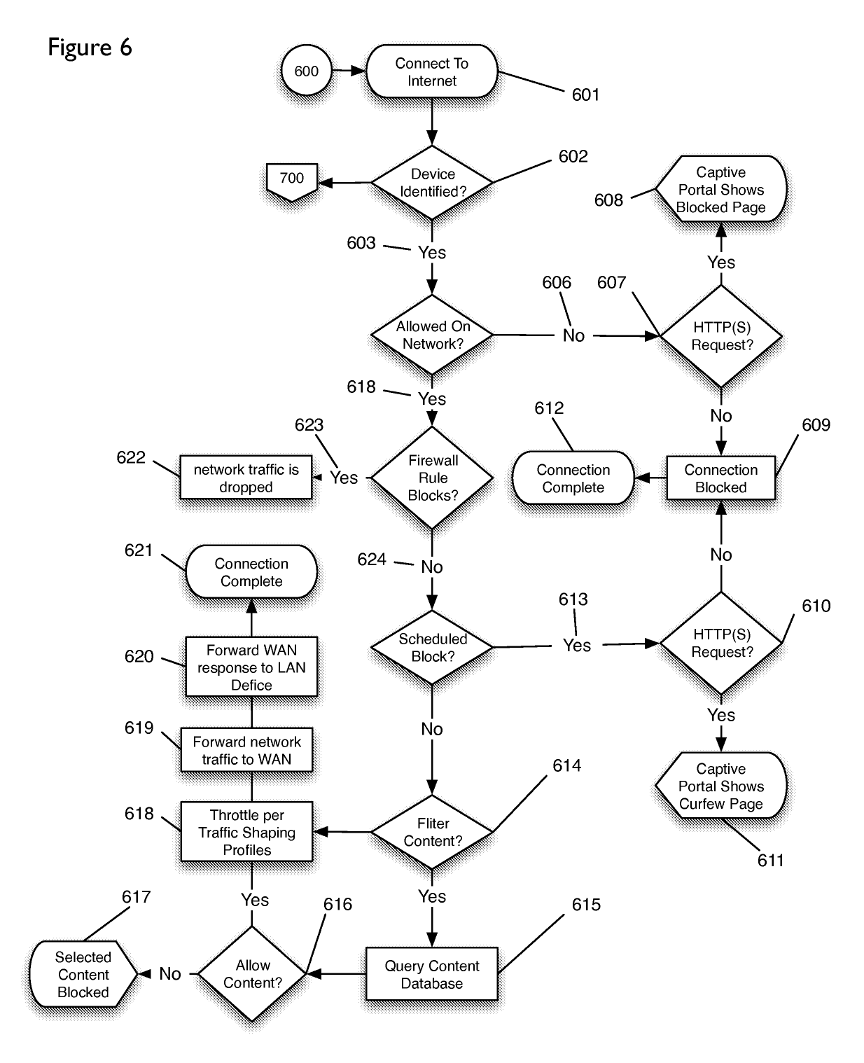

FIG. 7 illustrates the flow of decisions made when a new device joins the Local Area Network.

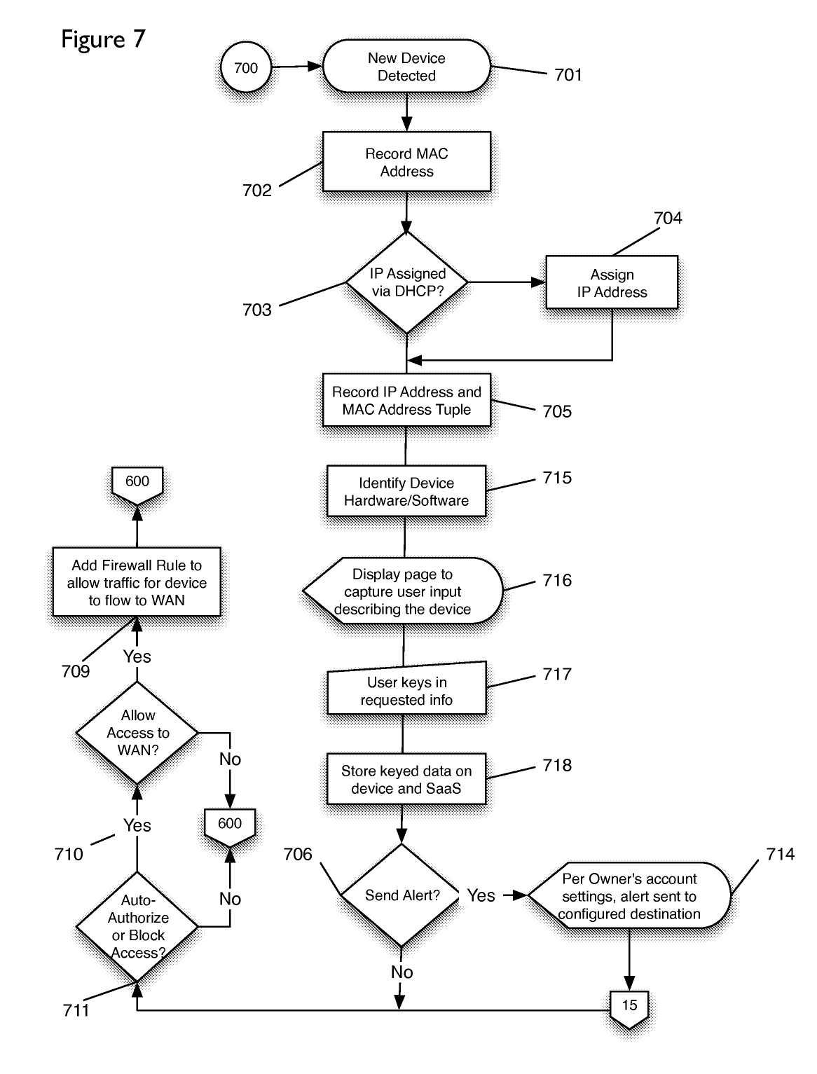

FIG. 8 is a sequence diagram showing role of the major components of the invention and their place in the chain of events when a device joins the Local Area Network and when the device is attempting to communicate with the WAN.

FIG. 9 illustrates the physical components of an embodiment that does not have wireless capabilities and is designed to work in conjunction with an external DSL/Cable modem.

FIG. 10 illustrates the physical components of an embodiment that has integrated wireless capabilities and is designed to work in conjunction with an external DSL/Cable modem.

FIG. 11 illustrates the physical components of the embodiment that does not have wireless capabilities and has integrated DSL/Cable modem capabilities.

FIG. 12 illustrates the physical components of the embodiment that has integrated wireless and DSL/Cable modem capabilities.

FIG. 13 illustrates the flow of decisions and actions taken to activate a new device when its first plugged into the network.

FIG. 14 is a block diagram illustrating various content included in a Request/Response exchange of a given embodiment of the solution.

FIG. 15 is a flow chart illustrating a method for routing and filtering content after an alert event is triggered.

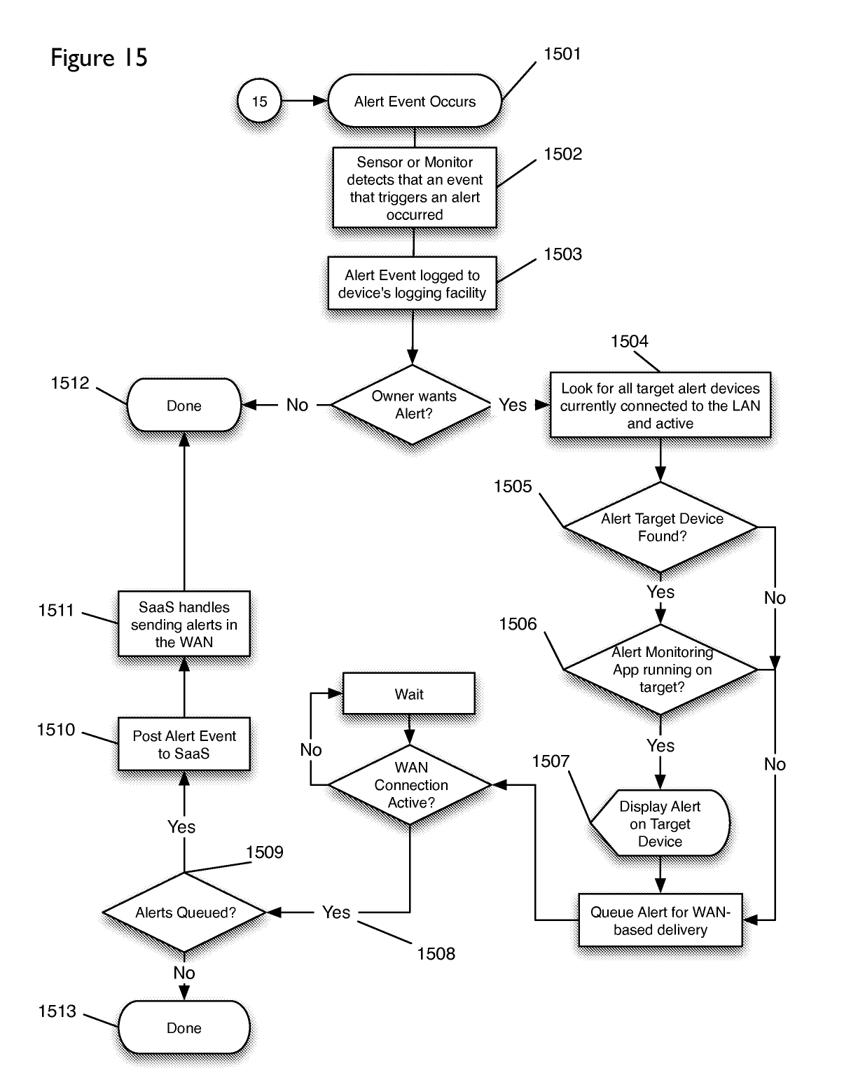

FIG. 16 is a flow chart(s) illustrating exemplary alert events that may precede the method of FIG. 15.

### DETAILED DESCRIPTION

Aspects, features and advantages of several exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute terms such as, for example, “will,” “will not,” “shall,” “shall not,” “must” and “must not” are not meant to limit the scope of the present invention as the embodiments disclosed herein are merely exemplary.

The word “exemplary” is used herein to mean “serving as an example, instance, or illustration.” Any aspect described herein as “exemplary” is not necessarily to be construed as exclusive, preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content,” as referred to herein, may also include files that are not executable in nature, such as documents that may need to be opened or other data files that need to be accessed.

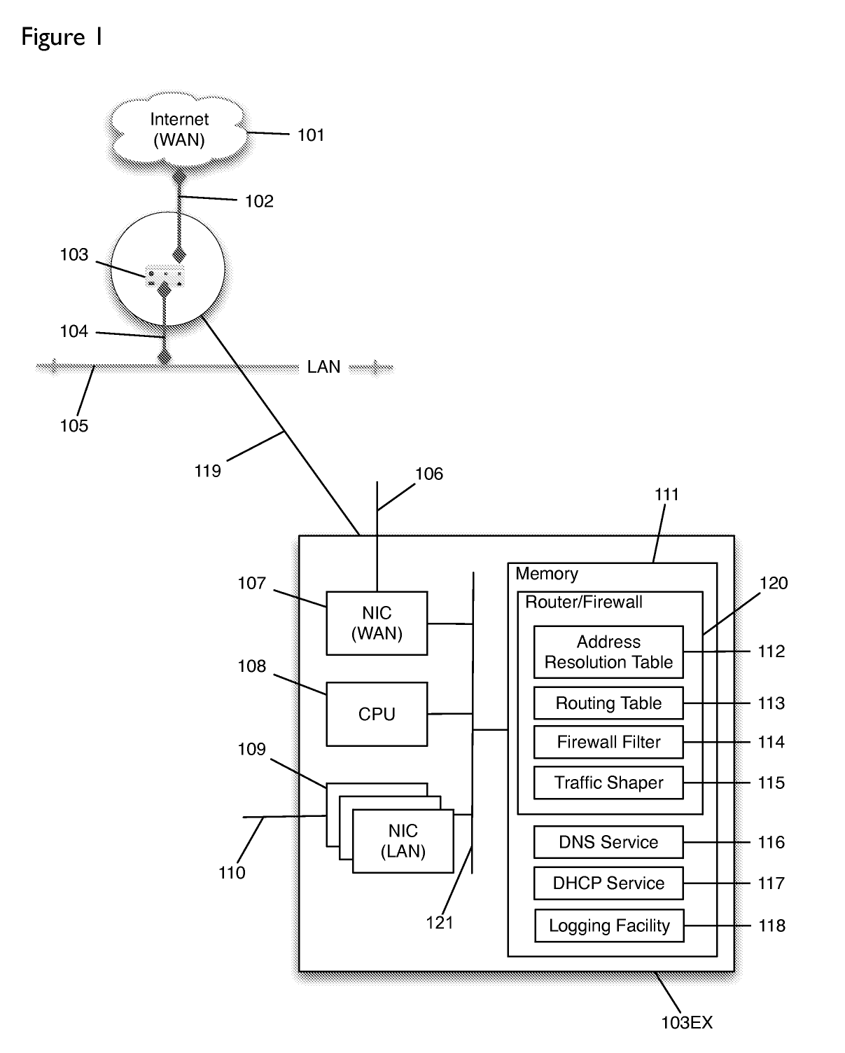

FIG. 1 shows a typical router 103 and its role as a gateway between the Internet/Wide Area Network (WAN) 101 and the Local Area Network (LAN) 105. A router is typically a physical device ranging from pocket-size to full-size servers, but may also be a virtualized server appliance (VPS). Routers generally have the internal components depicted in the callout 119 diagram 103EX and is typically connected to the WAN 101 via a network cable 102 to its WAN NIC 107 via the NIC's port 106 and to the LAN 105 via another network cable 105 to its LAN NIC 109 via the NIC's port 110. A typical router may contain one or more physical LAN ports 110. The network traffic on the LAN 105 is typically non-routable network packets as described in RFC 1918 that requires the router to perform Network Address Translation (NAT) in order to pass traffic upstream to the WAN 101 and return the replies back to the LAN 105. The NICs are connected to a system bus 121 to which also attached is a CPU 108 and Memory 111 which allows software to run that enables general networking and routing functions, as would be understood by one of ordinary skill in the art.

The software of a typical router 103 represented in the figures by the various components depicted in the illustration of memory 111 (112-118). The Address Resolution Table 112 tracks resolution of network layer addresses into link layer addresses, a critical function in multiple-access networks with the Address Resolution Protocol (ARP) defined by RFC 826. The Routing Table 113 tracks where network packets can be delivered while the Firewall Filter 114 can block or allow traffic to pass between NIC interfaces 106 and 110. The Traffic Shaper 115 can prioritize traffic via Quality of Service (QoS) rules as well as rate-limit (throttle) delivery of network traffic packets. Routers akin to router 103 also typically run a Dynamic Host Configuration Protocol (DHCP) service 117 to allow new networkable devices to connect to the LAN 105 and obtain IP addresses as well as DNS server data, as would be understood by one of ordinary skill in the art. Router 103 may also additionally run a DNS service 116 in order to locally cache domain name resolutions, as would be understood by one of ordinary skill in the art. A logging facility 118 is also typically present to record events and activities that occur on the device 103 to allow diagnostic and analysis of the router's performance and hardware/software issues.

Over the years, enterprise level routers or devices configured with similar networking components as router 103 and placed at the WAN to LAN gateway point were designed to protect corporate networks and variously called Intrusion Detection Systems (IDS), Intrusion Prevention Systems (IPS), Unified Threat Management (UTM) systems, Proxy/Caching servers. Their purpose was to give professional network administrators the ability to guard against malicious attacks or data coming into the corporate environment, speed up network overall performance through caching, protect devices on the corporate LAN from external threats (viruses, trojans, etc.), and monitor device usage and traffic crossing between the connected LAN 105 and WAN 101 networks. Many enterprise level solutions may implement a captive portal aspect whereby a user must sign in and register their name and/or contact info and oftentimes pay for services before being allowed to browse to the WAN 101. Enterprise level solutions, however, are inadequate for small/home network use as certain functionality and needs for home networking applications are not envisioned at the enterprise level.

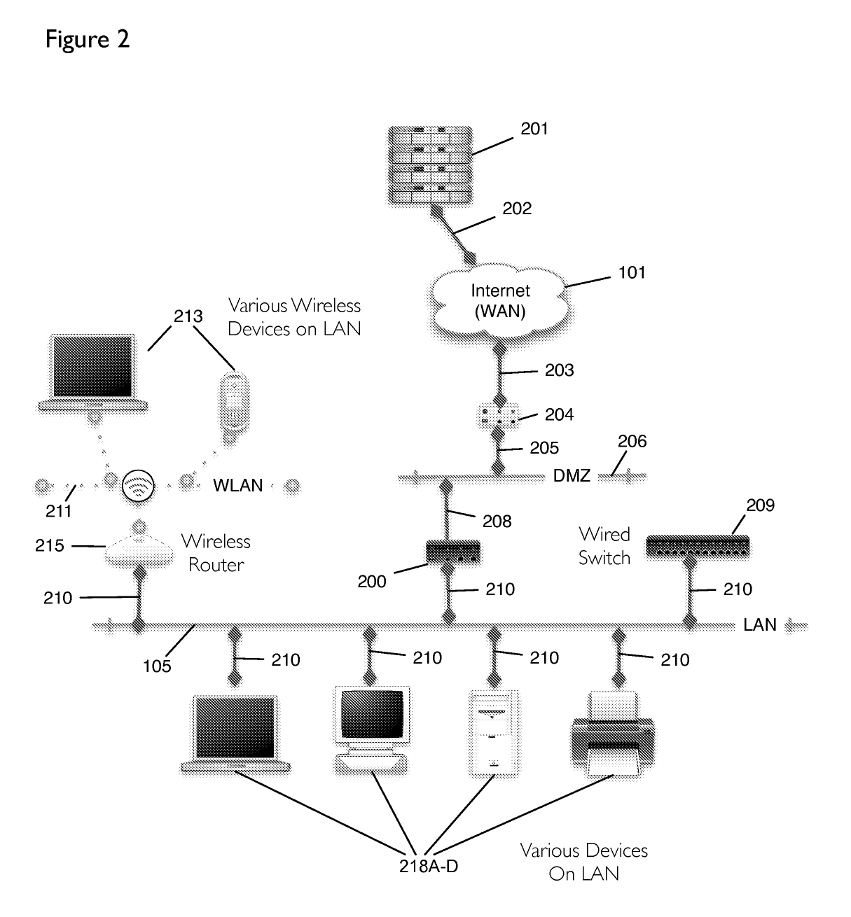

Turning now to FIG. 2, depicted is an exemplary embodiment 200 that is intended to be used in conjunction with an Internet Service Provider's (ISP) provided DSL/cable modem 204. In this configuration, the DSL/cable modem 204 is able to relay all traffic transported on the network's demilitarized zone (DMZ) 206 to the WAN 101 via the ISP's upstream gateway. When the embodiment 200 is connected in such manner, it may obtain its WAN IP Address from the DSL/cable modem 204 and will be able to route LAN 105 network traffic outside a firewall and onto the openly accessible DMZ 206 such that it can be routed to the WAN 101 by the DSL/cable modem 204. Conversely, traffic routed to the DMZ 206 by the DSL/cable modem 204 can be filtered and routed by the embodiment 200 onto the LAN 105, which may be consumed as appropriate by various network devices 218 on the LAN 101.

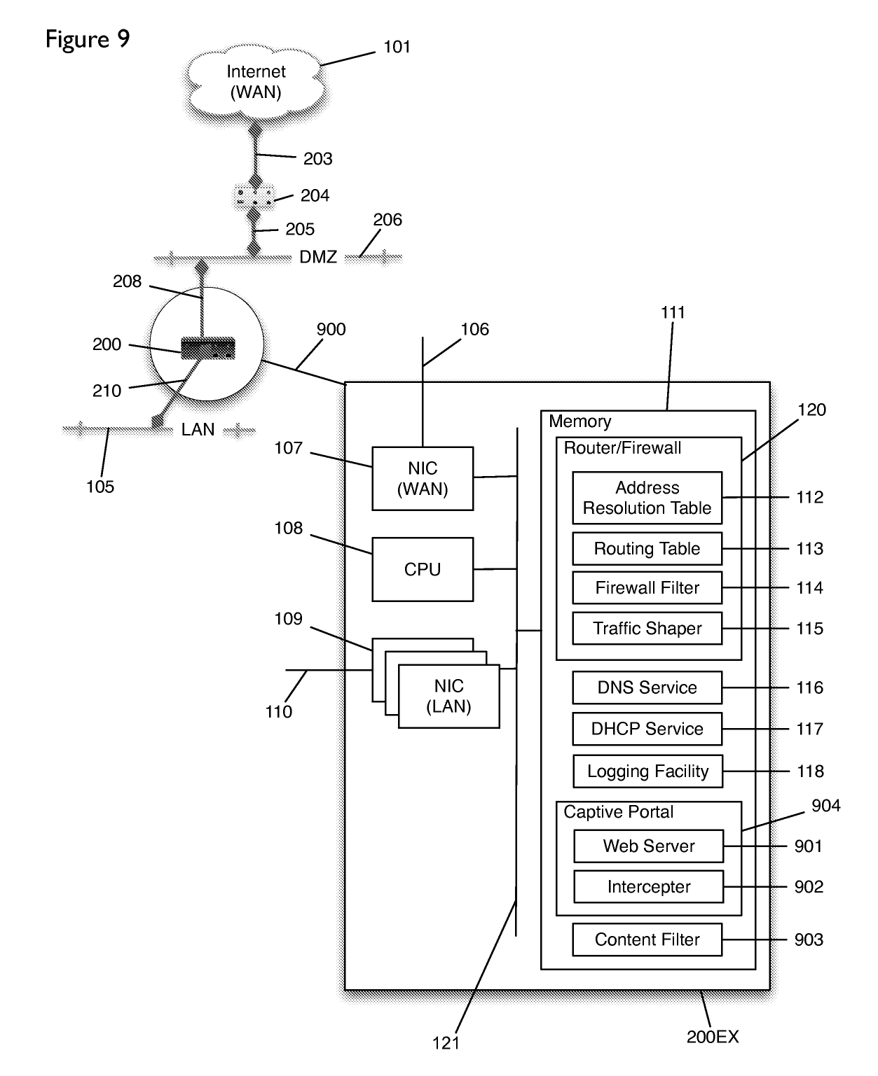

Turning now to FIG. 9, illustrated via the callout 900 to diagram 200EX are the physical components that may be comprised within the device 200 of FIG. 2. The embodiment is depicted with a WAN Network Interface Controller (NIC) 107 that is connected to the DMZ 206 via a network cable 208 to the physical port 106 of the invention. Notably, it is envisioned that the physical port 106 may be a universal serial bus (USB) port, although embodiments are not limited to using USB ports. Other connection/port types will occur to those with skill in the art and, as such, the particular types and combinations of ports included in a device 200 will not limit the scope of this disclosure.

Returning to the FIG. 9 illustration, the exemplary embodiment has one or more LAN NICs (109) and physical port(s) 110 to which devices (not depicted in FIG. 9) on the LAN 105 may be physically connected via a network cable 210. The WAN NIC 107, LAN NIC 109, CPU 108, and Memory 111 are interconnected via a system bus 121 that allows network traffic to be processed, filtered, altered and/or routed from WAN 101 to LAN 105. Embodiments of the solution may have all of the components of a standard router/firewall device 103, including, but not limited to Address Resolution Table 112, Routing Table 113, Firewall Filter 114, and Traffic Shaper 115 as described above. Certain embodiments of the solution may include a Captive Portal 904 which implements an interceptor 902 for scanning network traffic, identifying content, source, destination, and marking time of transit and choosing to intercept and either block or redirect in the case of HTTP and HTTPS (abbreviated “HTTP(s)” to represent either or both protocols) traffic to web pages served by the captive portal's associated web server 901.

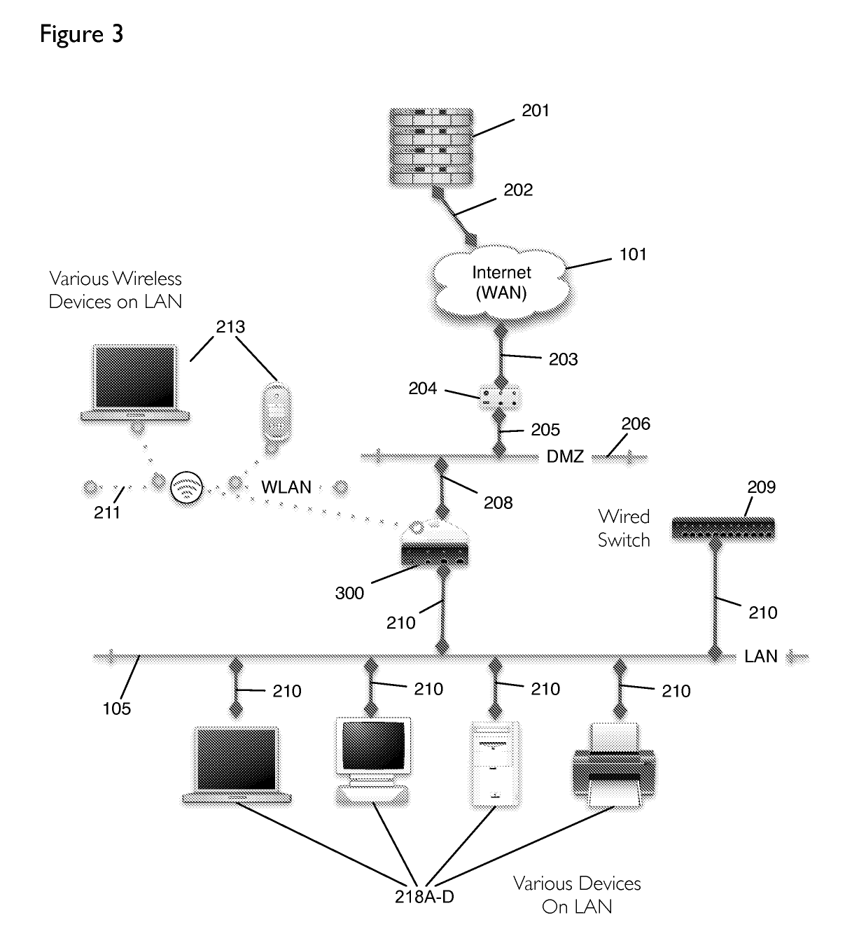

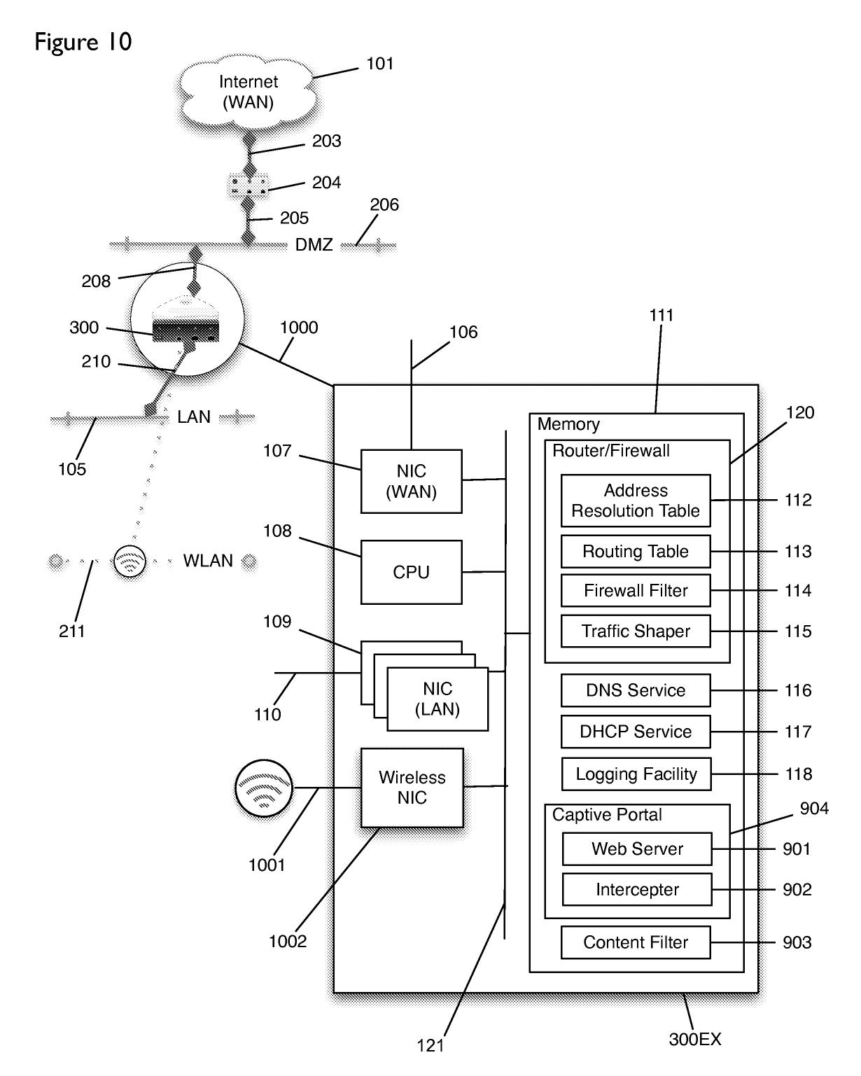

Turning now to FIG. 3, shown is an embodiment 300 that, in addition to the components and features described relative to the FIG. 2 embodiment 200 may further comprise a wireless NIC as shown and described in FIG. 10 via the callout 1000 to the diagram 300EX, which is similarly attached to the system bus 118. The Router/Firewall 300 is additionally configured so that traffic is similarly routed from the WLAN 211 to the WAN 101.

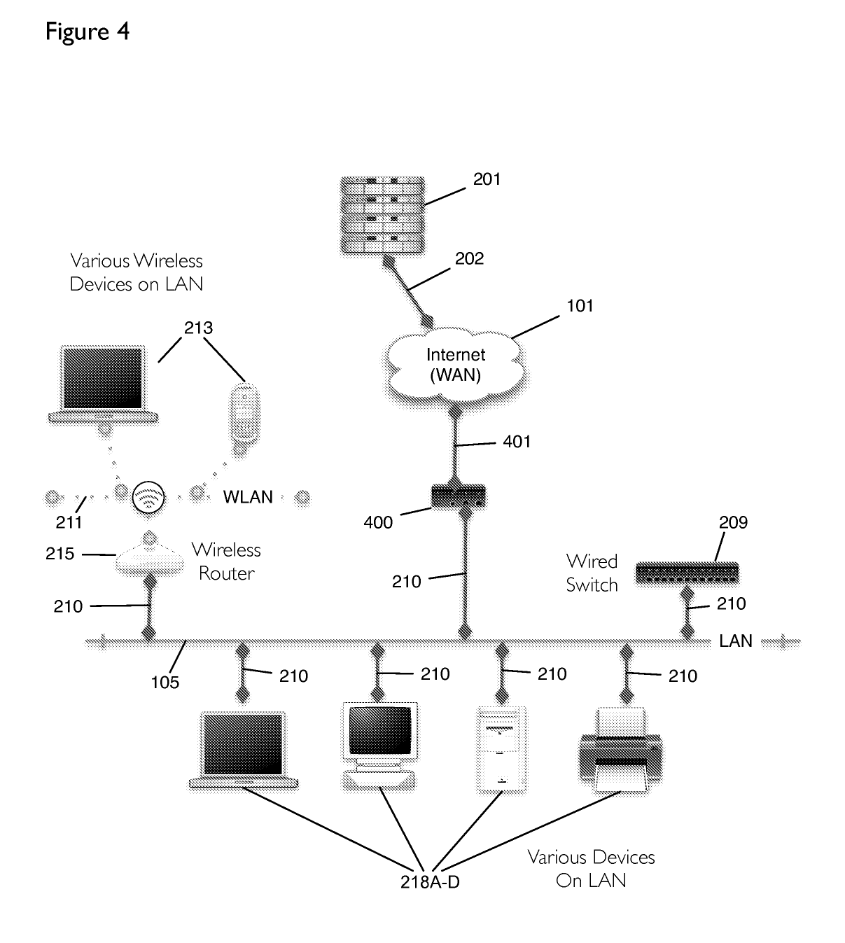

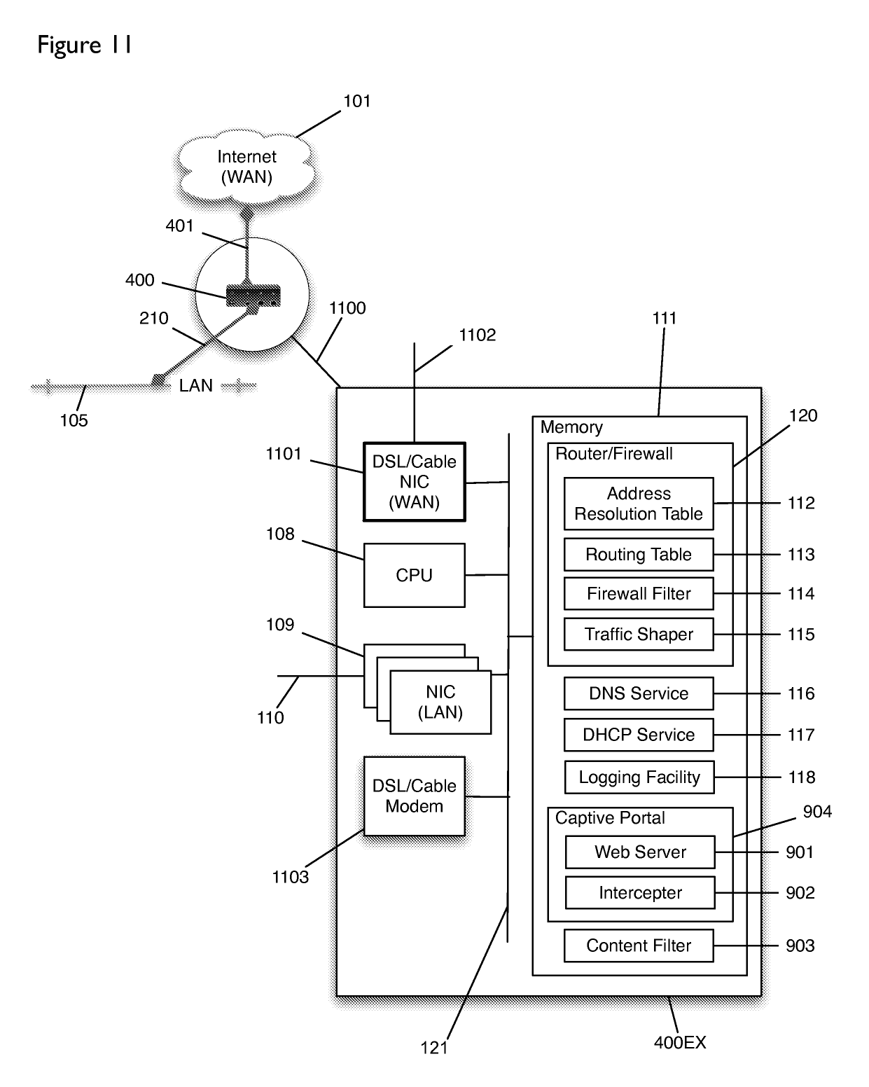

FIG. 4 shows an embodiment 400 that may contain all of the components and features as described in the first embodiment 200 in FIG. 2. As shown in detail in FIG. 11 via callout 1100 to diagram 400EX, this embodiment 400 adds a DSL/Cable NIC 1101 along with supporting DSL/Cable Modem 1103 and allows the solution to be directly attached via a network cable or coaxial cable or fiber optic cable 401 to its physical port 1102 to the WAN 101.

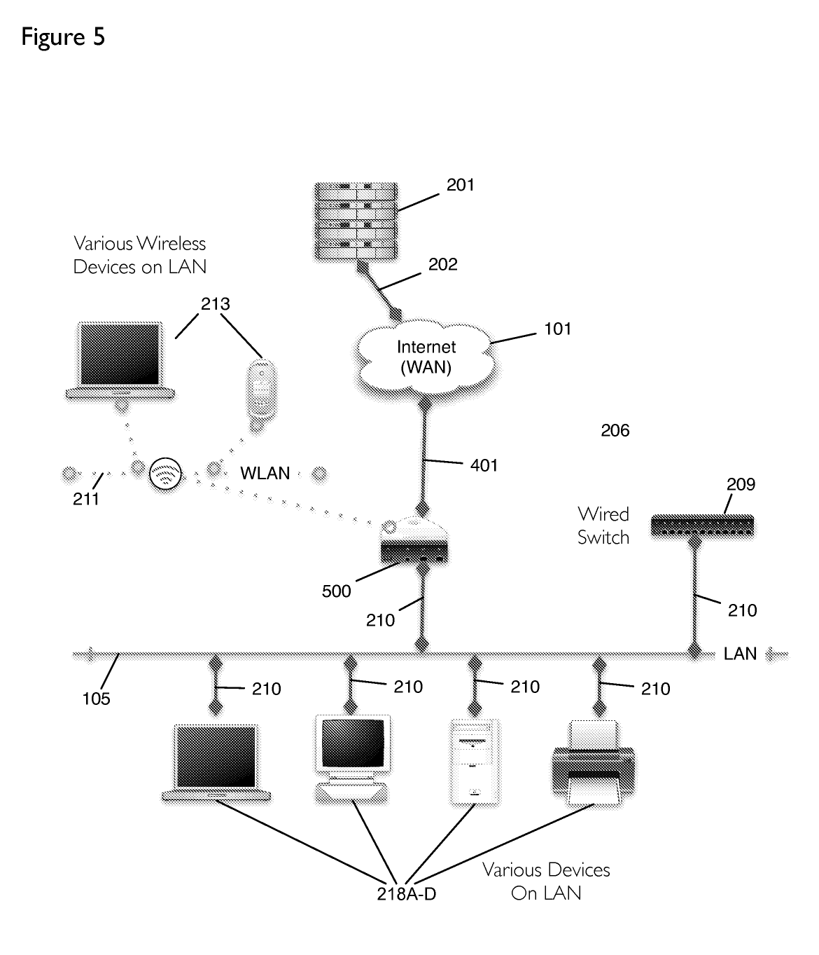

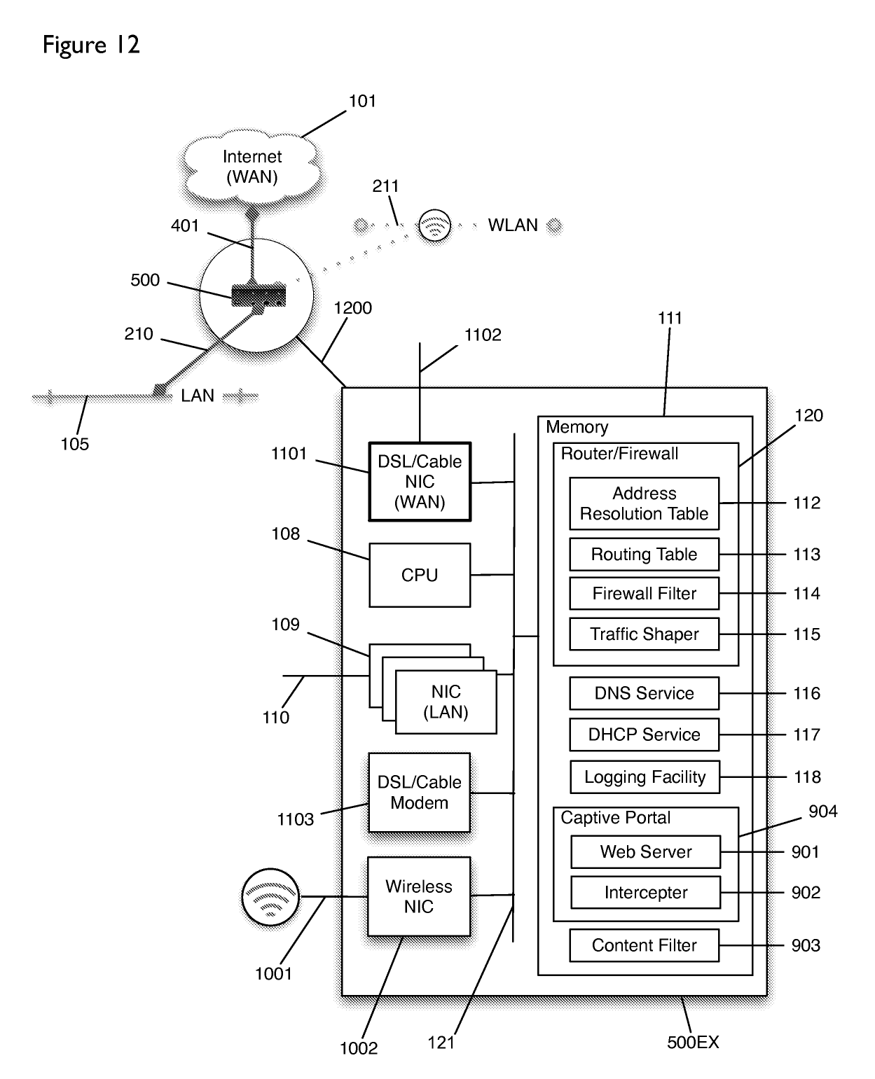

FIG. 5 shows an embodiment 500 that may contain all of the components and features as described in the second embodiment 300 in FIG. 3. As shown in detail in FIG. 12 via callout 1200 to diagram 500EX, this embodiment 500 adds a DSL/Cable NIC 1101 along with supporting DSL/Cable Modem 1103 and allows the solution to be directly attached via a network cable or coaxial cable or fiber optic cable 401 to its physical port 1102 to the WAN 101.

In certain embodiments of the solution, there may exist an application for determining the first time the embodiment is connected to the network and turned on for the first time. In this state, the embodiment is considered to be in the unactivated state and may therefore initialize the Router/Firewall 120 rules such that all HTTP(S) traffic is intercepted and redirected by the Captive Portal 904. A user's attempt to browse the WAN through the embodiment may trigger the display of a Welcome Page 1320 that steps the user through an activation process. During the activation steps, the embodiment may communicate with the Software as a Service (SaaS) 201 module that resides in the WAN 101 to establish the user's account, register the embodiment with the SaaS and store profile configuration options that tailor the embodiment's behavior to the user's preference with regards to which alerts the user wants and destination of the alerts as well as content filter options, scheduled block options, etc.

Notably, although the exemplary embodiments offered herein are described within the context of controlling and filtering access to Internet content via a gateway for HTTP(S) traffic, the scope of the solutions are not limited to monitoring, filtering and controlling content requests and content delivery in a network that accommodates HTTP(S) protocol. One of ordinary skill in the art will recognize that the solution may be applied within any networked environment where a goal is to control access levels for multiple networked devices that reside on one side of the router/firewall device to content that resides on the other side of the router/firewall device. As such, the particular protocol used by a network will not limit the application of the envisioned solutions.

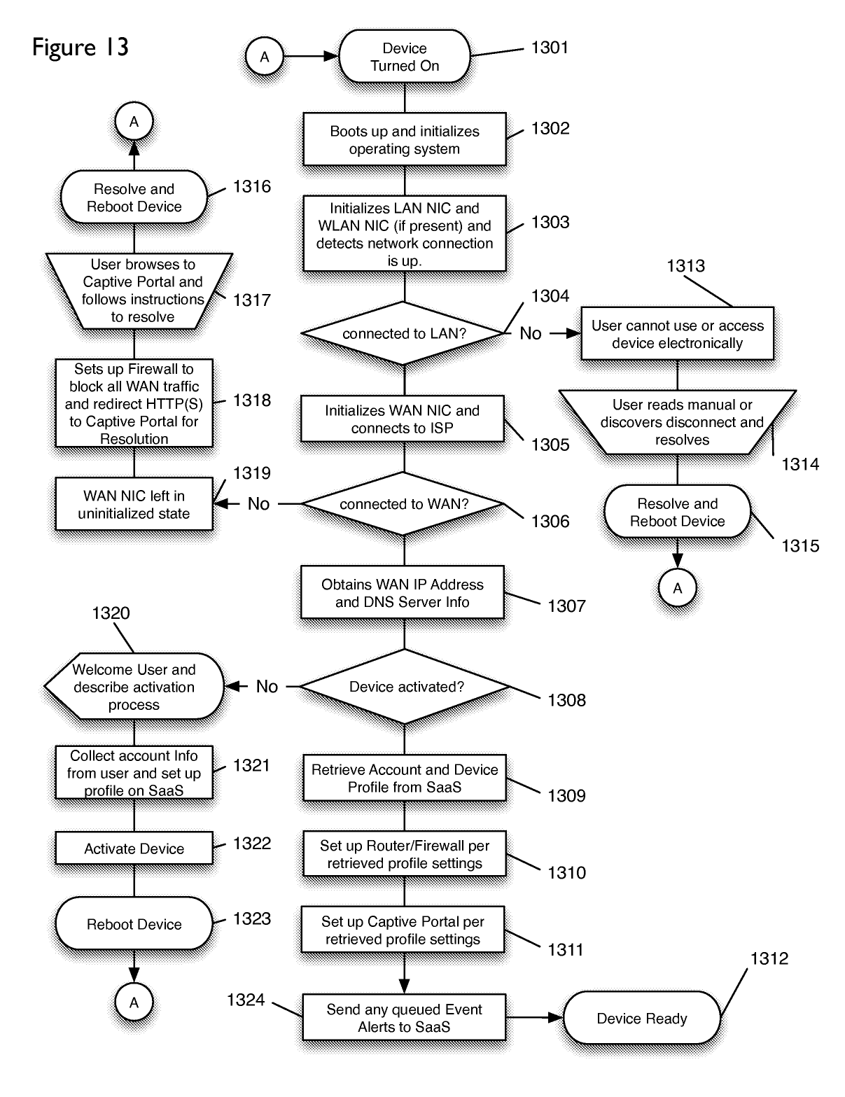

Referring to the FIG. 13 method, when a device (i.e., an embodiment of the solution) is first turned on at block 1301, the operating system boots up and begins loading each of the system components (112-118). If the system is not connected to a LAN 1304 then the device is effectively unreachable by the user with a browser running on a network device (213 or 218) until resolved with manual intervention 1314. If the device is not connected to the WAN, then the Router/Firewall 120 rules are configured 1318 to redirect all HTTP(S) traffic to the Captive Portal 904 which will present troubleshooting pages that help the user resolve connectivity issues 1317. Once the device is connected to the LAN and to the WAN, it can be activated by the user 1320 through 1322. If the device is activated 1308 and connected to both the LAN 1304 and WAN 1306, then the device proceeds to set up the Router/Firewall 120 per the user's account settings and preferences retrieved from the SaaS 201 as well as stored on the device itself in onboard memory 111.

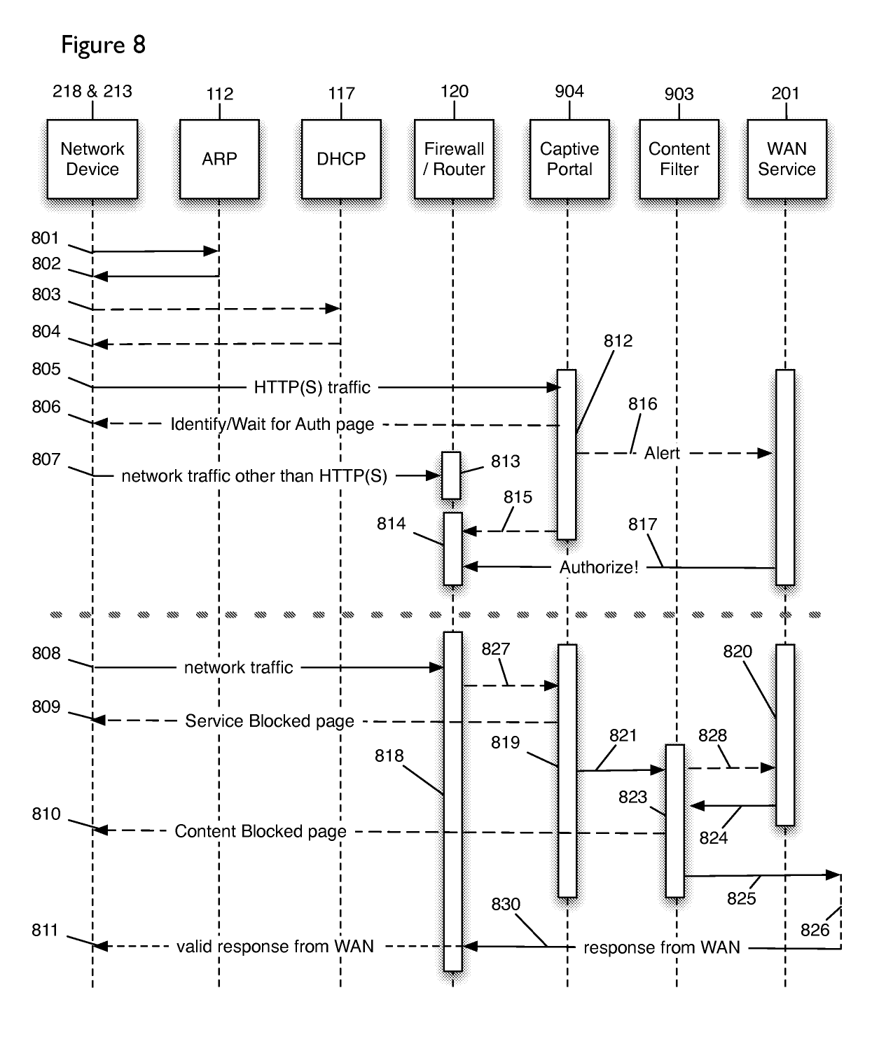

In certain embodiments, when an activated device boots up and connects to LAN and WAN, and arrives at step 1309 in FIG. 13, the firewall rules are configured such that all outgoing traffic to the WAN except traffic initiating from the device itself is dropped as shown in FIG. 8 item segment 813. Any network device 218 & 213 that joins the network begins by broadcasting its presence and thus detected and its MAC address registered by the router/firewall device. The network device is blocked from WAN access by virtue of the Firewall Filter 113 not having any rules associated with the network device's MAC or IP address to pass through. If the network device initiates a DHCP request 803, the DHCP Service 117 will grant an available IP Address to the network device, thus allowing the network device to communicate on the LAN 105 or WLAN 211. All HTTP(S) requests originating from the network device and destined for the WAN 101 will result in the Firewall rules redirecting the traffic to the captive portal's 904 Interceptor 902 which will send a response 806 redirecting the network device's browser to the appropriate page served by the Captive Portal's Web Server 901. When the device is unknown 602, the appropriate page(s) are displayed to step the user through identifying the device 603 and sending new device detected alert 1606 to the administrator of the router/firewall device (such as, for example, to a cell phone associated with the administrator). If the administrator has configured the account settings to auto-grant access 710 to new devices, then appropriate firewall rules are inserted 815 into the firewall filter 114 and the next WAN request from the network device will follow the sequence of events starting with 808. If the network device attempts to connect to WAN via HTTP(S) before authorization 817 has been granted by the SaaS 201, then the captive portal will intercept the request and respond with a redirect to its Web Server 901 with Wait for Authorization Page.

In certain embodiments, once a network device has been identified 603 and authorized 618 to access the WAN, all requests flow along the sequence that begins at 808 in the sequence diagram of FIG. 8. If a Firewall rule matches the traffic flow 623, then the packet is simply dropped at the Firewall 818 with no response returned. If there is no matching rule 624, then the network traffic 827 is received by the captive portal. If the network device is explicitly blocked 606 or the network traffic occurs during a scheduled block 613 then the captive portal intercepts the request and responds with a redirect to the Service Blocked page which served by the Captive Portal's Web Server 901. Traffic that is not blocked for non-content related reasons are then passed through the Content Filter module 903. If the resource request was recently requested and cached in the Content Filter 903 and it is blocked, then HTTP(S) traffic results in a Content Blocked page 810 response being returned to the Network Device while non-HTTP(S) traffic is dropped by the Firewall 818. If the requested resource is not cached, a request 1401 is constructed with the requested network resource 1406 (which may be a Universal Resource Identifier (URI) or an IP Address) is passed upstream 828 to the WAN Service (SaaS) 820 where the resource 1406 gets categorized and matched to the user account's content filter profile for the Router/Firewall Device and Network Device making the request. The SaaS makes the determination whether to block or allow the Network Device's request and returns a Response 1402 with the Block Flag 1408 set accordingly. Additional informative data (1409-1412) is returned to allow the Captive Portal to respond to blocked HTTP(S) requests with a Blocked Content Page 810 in the event that the requested resource is blocked. If the resource is not blocked, the network traffic 825 is routed to the WAN 101 which, when a response 830 is received, it is processed by the firewall 818 where the response may be dropped if it is invalid or exceeds rate limits established by the Firewall Filter 114 or Traffic Shaper 115. If the response is not dropped, the response 811 is routed to the Network Device.

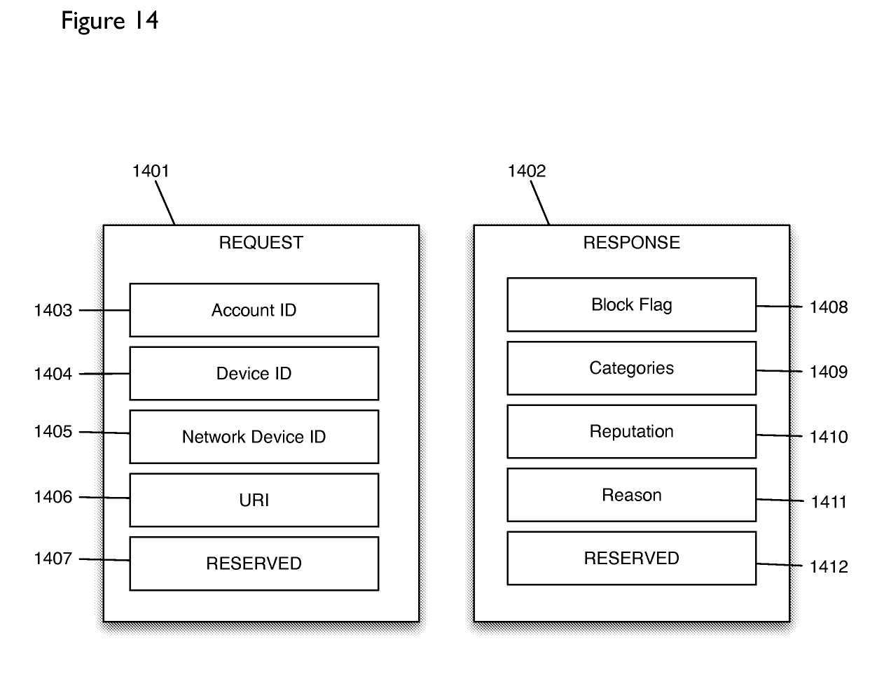

The foregoing content query request 1401 and response 1402 from FIG. 14 has been presented for purposes of illustration and description. It is not intended to be exhaustive or to limit the invention to the precise form disclosed. Many modifications and variations are possible in light of the above teachings. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

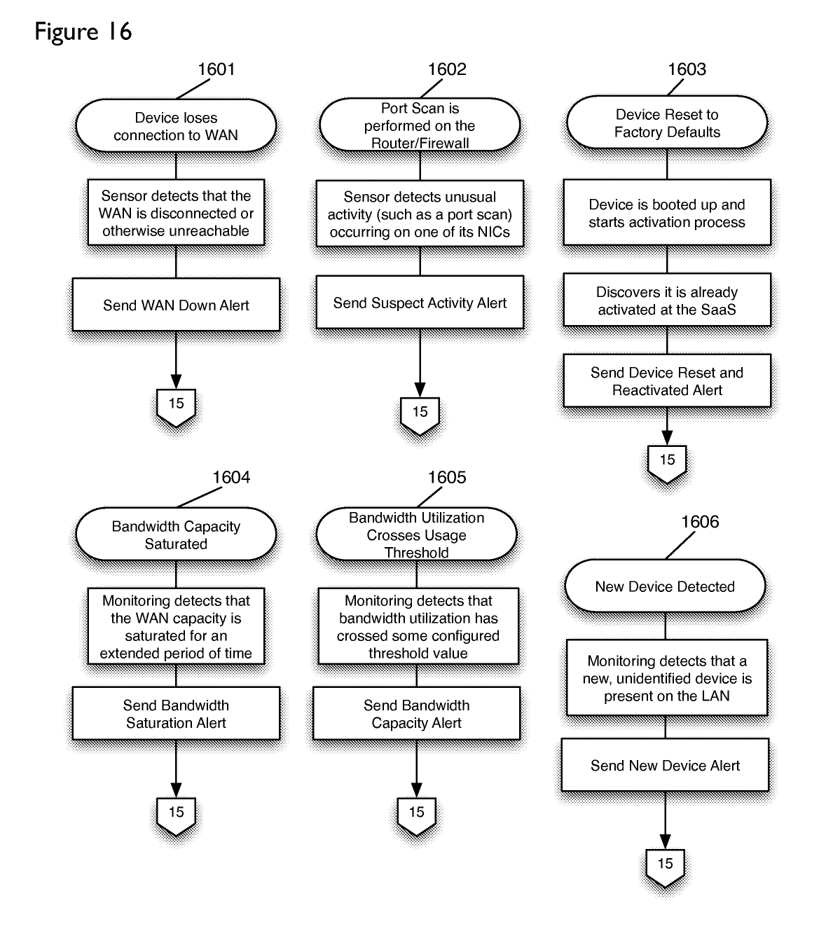

In all embodiments, alerts of various nature as depicted in FIG. 16 can be sent by the device when the triggering event occurs. Delivery methods and targets (such as, but not limited to, emails, SMS messages, and Account notifications on the SaaS) can be configured for the device and optionally turned off for selected triggering events. When an event triggers the alert mechanism 15, an Alert Event may occur 1501 and the event may be written to the device's logging facility regardless of the administrator's preferred settings. If the administrator does not want an alert then the alert mechanism completes. Otherwise, the alert mechanism first looks for a network device that has been configured as an alert target on the LAN 1504. If such target device is found then the device attempts to connect to running alert monitoring app 1506. If the connection is successful, the alert is delivered to the device and is displayed 1507 to the user. The message may be queued for delivery to the SaaS 201. If the WAN connection is active 1508, then the Alert Event is sent to the SaaS 1510 after which the SaaS takes over 1511 delivering to targets in the WAN 101.

The foregoing alerts 1601, 1602, 1603, 1604, 1605, and 1606 presented in FIG. 16 have been presented for purposes of illustration and description. It is not intended to be exhaustive or to limit the invention to the precise alerts described. Many modifications and variations are possible in light of the above teachings. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

The described embodiments comprise different features, not all of which are required in all embodiments of the disclosed router/firewall solution. Some embodiments utilize only some of the features or possible combinations of the features. Variations of embodiments of the solution that are described and embodiments comprising different combinations of features noted in the described embodiments will occur to persons of the art.

Additionally, certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the drawings, which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Therefore, although selected aspects have been illustrated and described in detail, it will be understood that various substitutions and alterations may be made therein without departing from the spirit and scope of the present invention, as defined by the following claims.

What is claimed is:

1. A networked device for routing and filtering content requests to a wide area network (“WAN”), the networked device comprising:
the structures as described above and illustrated in the attached drawings.

2. A method for routing and filtering content requests to a wide area network (“WAN”) through a router/filter gateway device, the method comprising:
the steps as described above and illustrated in the attached drawings.
